(19) United States
(12) Patent Application Publication
(10) Pub. No.: US 2020/0065162 A1
(43) Pub. Date: Feb. 27, 2020

(54) TRANSPARENT, EVENT-DRIVEN PROVENANCE COLLECTION AND AGGREGATION

(71) Applicant: International Business Machines Corporation, Armonk, NY (US)

(72) Inventors: Deepavali Bhagwat, Cupertino, CA (US); Lukas Rupprecht, San Jose, CA (US); Wayne Sawdon, San Jose, CA (US); Frank N. Lee, Sunset Hills, MO (US); Joseph Dain, Vail, AZ (US)

(73) Assignee: International Business Machines Corporation, Armonk, NY (US)

(21) Appl. No.: 16/112,664

(22) Filed: Aug. 25, 2018

(51) Int. Cl. G06F 9/54; G06F 17/30

(52) U.S. Cl. CPC G06F 9/542; G06F 17/30569

(57) ABSTRACT

A method for collecting digital provenance from heterogeneous sources is disclosed. In one embodiment, such a method includes detecting events generated by multiple heterogeneous sources. The method further filters the events to extract relevant events therefrom. The method further transforms the relevant events into a standard format and saves the relevant events in a queue. The relevant events are then consumed from the queue. Consuming relevant events in the queue includes determining actions to be performed for each relevant event in the queue. These actions may include collecting digital provenance associated with the relevant events. The method then executes the actions. A corresponding system and computer program product are also disclosed.

### FIELD OF THE INVENTION

This invention relates to systems and methods for collecting and aggregating digital provenance.

### BACKGROUND OF THE INVENTION

Tracking digital provenance is important in every compute and analytical environment. Digital provenance describes the lineage of data which includes all parent data from which the data was derived and corresponding transformations on the parent data that produced it. Thus, provenance captures the pedigree of data, thereby allowing scientists to verify and judge sources, quality, and trustworthiness of the content.

In a computing and analytical environment, digital provenance may be recorded at different stages and at varying levels of granularity. For example, low-level, system-call-based provenance collection may track data accesses and the context of those accesses. Application-level provenance, by contrast, may track application semantics employed when accessing and transforming data. High-level, service-based provenance, by contrast, may capture cross-application dependencies between data.

Provenance collected at each of the above-described stages is important to providing complete data lineage. Without collecting information regarding which actors and actions access and transform data at each of the stages, the data lineage is incomplete. However, combining provenance from multiple entities is often challenging as entities frequently operate independently from one another and do not share a common, direct communication channel.

Providing comprehensive data lineage enables scientists and administrators to make complex inferences about their specific environment. For example, if digital provenance captures detailed resource usage associated with individual stages of a complex workflow, data center administrators may use it to guide and optimize resource provisioning when a job is rerun, pre-fetch data for different workflow stages, or prepare detailed pricing models for a job that is run on public infrastructure. For scientists, digital provenance may enable reproducibility in scientific computing as they can replay transformations captured in the data lineage to test the veracity of inferences. It may also be used to improve data discoverability and understandability as the collected metadata may be indexed, made searchable, and used for various data services such as enforcing geographic compliance rules.

In view of the foregoing, what are needed are systems and methods to more efficiently collect and aggregate digital provenance information in computing, storage, and analytical environments.

### SUMMARY

The invention has been developed in response to the present state of the art and, in particular, in response to the problems and needs in the art that have not yet been fully solved by currently available systems and methods. Accordingly, systems and methods have been developed to collect and aggregate digital provenance from heterogeneous sources. The features and advantages of the invention will become more fully apparent from the following description and appended claims, or may be learned by practice of the invention as set forth hereinafter.

Consistent with the foregoing, a method for collecting digital provenance from heterogeneous sources is disclosed. In one embodiment, such a method includes detecting events generated by multiple heterogeneous sources. The method further filters the events to extract relevant events therefrom. The method further transforms the relevant events into a standard format and saves the relevant events in a queue. The relevant events are then consumed from the queue. Consuming relevant events in the queue includes determining actions to be performed for each relevant event in the queue. These actions may include collecting digital provenance associated with the relevant events. The method then executes the actions.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one example of a storage system in the network environment of FIG. 1;

FIG. 3 is a high-level block diagram showing a framework for collecting digital provenance from heterogeneous sources;

FIG. 4 is a high-level block diagram showing internal steps or components within a collector;

FIG. 5 is a high-level block diagram showing an event generator component within a source such as a node;

FIG. 6 is a high-level block diagram showing various actions that may be performed by shepherds; and

FIG. 7 is a high-level block diagram showing aggregators that aggregate digital provenance to produce a data lineage for data objects.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

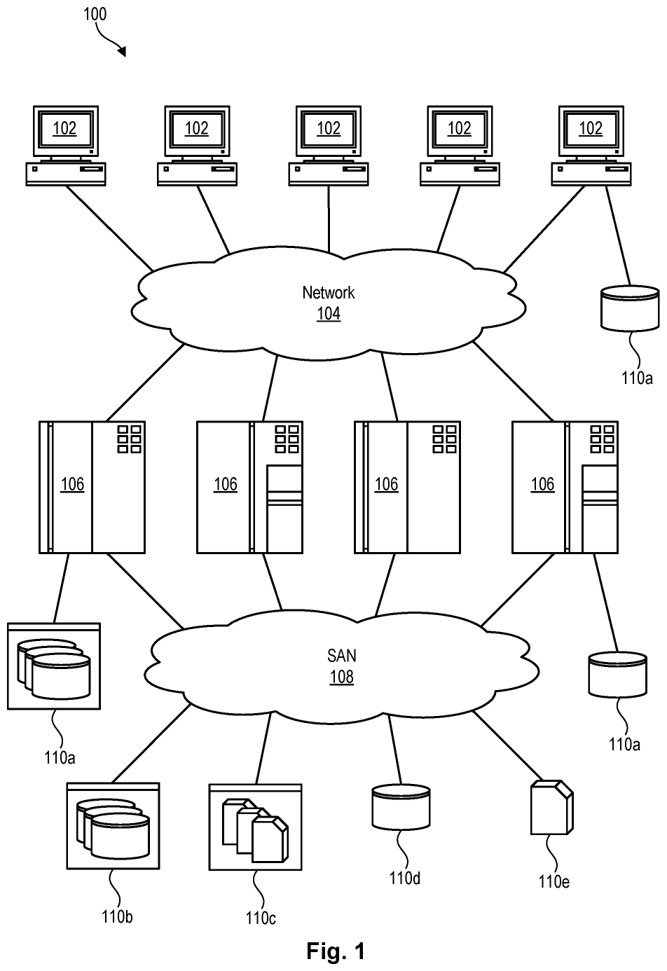

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of different network environments, in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 110a (e.g., arrays of hard-disk drives, solid-state drives, tape drives, etc.). These computers 102, 106 and direct-attached storage systems 110a may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110b of hard-disk drives or solid-state drives, tape libraries 110c, individual hard-disk drives 110d or solid-state drives 110d, tape drives 110e, virtual tape systems, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC).

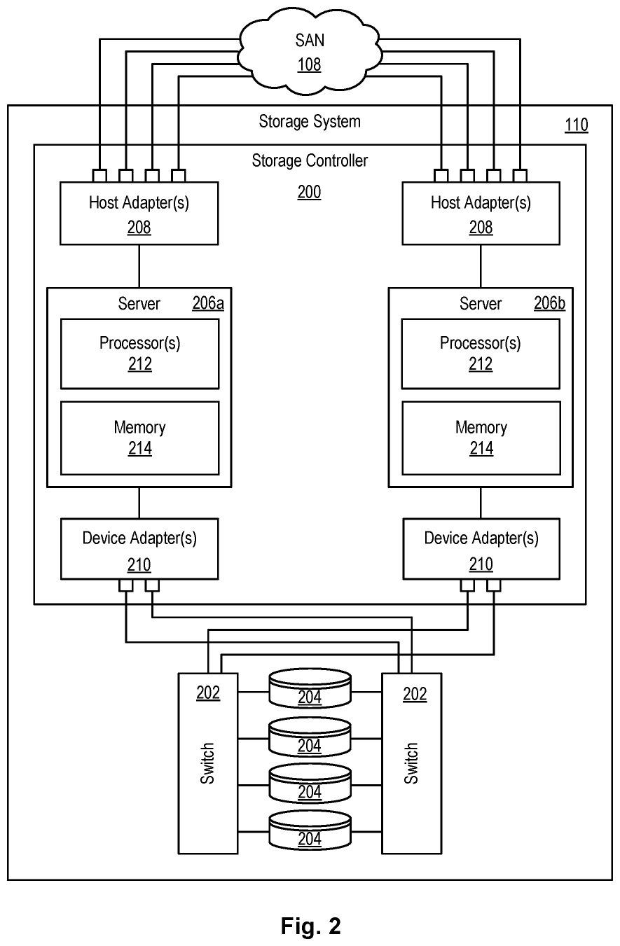

Referring to FIG. 2, one embodiment of a storage system 110 containing an array of hard-disk drives 204 and/or solid-state drives 204 is illustrated. As shown, the storage system 110 includes a storage controller 200, one or more switches 202, and one or more storage drives 204, such as hard disk drives 204 or solid-state drives 204 (such as flash-memory-based drives 204). The storage controller 200 may enable one or more hosts 106 (e.g., open system and/or mainframe servers 106 running operating systems such z/OS, zVM, or the like) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. These software modules may manage all read and write requests to logical volumes in the storage drives 204.

One example of a storage system 110 having an architecture similar to that illustrated in FIG. 2 is the IBM DS8000™ enterprise storage system. The DS8000™ is a high-performance, high-capacity storage controller providing disk storage that is designed to support continuous operations. Nevertheless, the systems and methods disclosed herein are not limited to operation with the IBM DS8000™ enterprise storage system 110, but may operate with any comparable or analogous storage system 110, regardless of the manufacturer, product name, or components or component names associated with the system 110. Furthermore, any storage system that could benefit from one or more embodiments of the invention is deemed to fall within the scope of the invention. Thus, the IBM DS8000™ is presented by way of example and is not intended to be limiting.

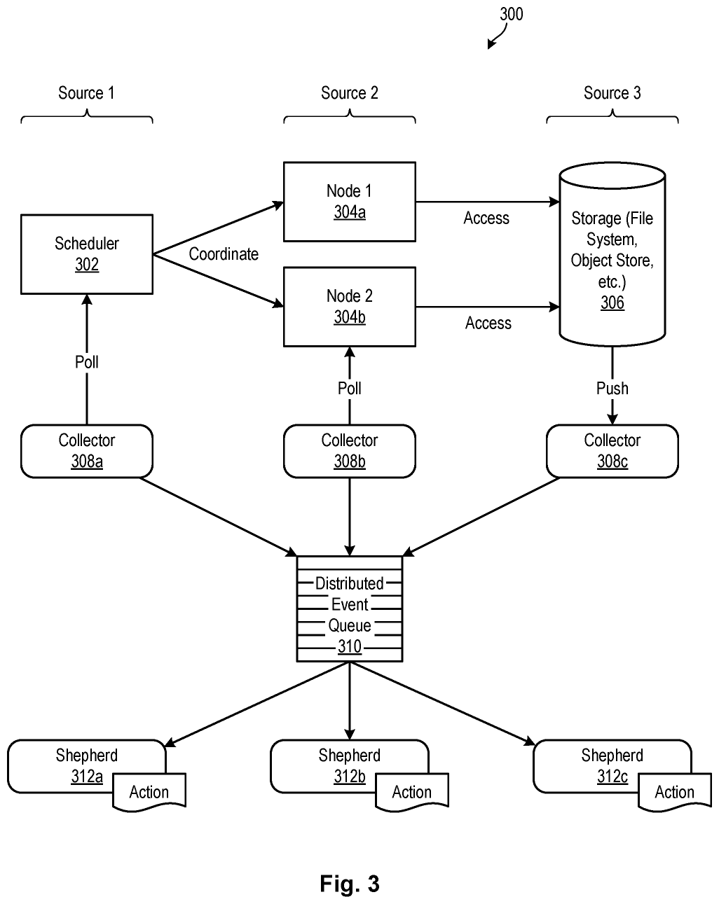

Referring to FIG. 3, as previously mentioned, tracking digital provenance is important in every compute and analytical environment. Digital provenance describes the lineage of data which may include all parent data from which the data was derived and corresponding transformations on the parent data that produced it. The digital provenance may be use to capture the pedigree of data, thereby allowing scientists to verify and judge sources, quality, and trustworthiness of the content.

In a computing and analytical environment, digital provenance may be recorded at different stages and at varying levels of granularity. For example, low-level, system-call-based provenance collection may track data accesses and the context of those accesses. Application-level provenance, by contrast, may track application semantics employed when accessing and transforming data. High-level, service-based provenance, by further contrast, may capture cross-application dependencies between data.

Provenance collected at each of the above stages is important to providing complete data lineage. Without collecting information regarding which actors and actions access and transform data, the data lineage is incomplete. However, combining digital provenance from multiple entities is often challenging as entities frequently operate independently from one another and do not share a common, direct communication channel. Thus, systems and methods are needed to more efficiently collect and aggregate digital provenance information from heterogeneous sources.

FIG. 3 shows an exemplary framework 300 for collecting digital provenance from heterogeneous sources. In this example, the heterogeneous sources include a scheduler 302, nodes 304a, 304b (such as host systems 106); and storage 306 such as a file system or object store. The storage 306 may be provided by a storage system 110 such as the IBM DS8000™ enterprise storage system previously discussed. Other heterogeneous sources are possible and within the scope of the invention.

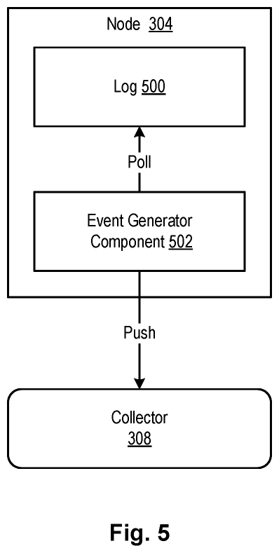

Each of the heterogeneous sources may generate different types of events depending on the source. For example, the storage 306 may generate an event each time a file is created, changed, written to, read from, deleted, or the like. These events may be generated in real time as the changes or actions occur. For sources that do not natively generate events, information such as logs associated with the sources may be periodically polled to generate events for the sources. For example, as shown in FIG. 5, in certain embodiments, an event generator component 502 may, in certain embodiments, be installed in a source (in this example a node 304). The event generator component 502 may be configured to look for (i.e., poll) events in a record 500 such as a log 500. If an event is found, the event generator component 502 may push the event to a collector 308. In this way, an event generator component 502 may be used to cause a source that does not normally generate events, to generate events. This may be accomplished without modifying application or operating system code on the source.

As shown in FIG. 3, various components 308, 310, 312 are illustrated. These components may be implemented in software, hardware, firmware, or a combination thereof. Components referred to herein as collectors 308 may be configured to gather events from the various heterogeneous sources and log and store information associated about these events in a distributed event queue 310. A collector 308 may detect events that are generated by a source, or a collector 308 may poll a source, such as be reading a log or other record of the source, to extract events therefrom. In certain embodiments, a collector 308 is tailored to the particular source from which it gathers events. For example, a collector 308 may be configured to know where to look for events associated with a particular source or understand the format and content of events emitted by or gathered from a particular source. Once received or gathered, the collectors 308 may publish the events to the distributed event queue 310. The distributed event queue 310 may be “distributed” in that it may be used to accumulate events from collectors 308 associated with different sources in a distributed environment.

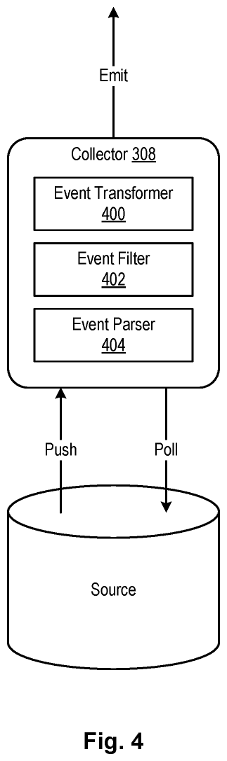

Referring to FIG. 4, while continuing to refer generally to FIG. 3, in certain embodiments, collectors 308 may contain various internal components to perform various features and functions. For example, a collector 308 may include an event parser 404 to extract events from a source. An event parser 404 may parse logs or other records of a source to extract events therefrom. The event filter 402, by contrast, may filter the events to extract events that are deemed to be relevant. For example, some types of events may be of interest while other types of events may be of no interest. Those not of interest may be ignored or filtered out. In certain embodiments, higher level events (e.g., reads, writes, opens, closes, etc.) may be retained while lower level events (e.g., system calls) may be ignored or filtered out. Events that are collected and/or ignored may be configurable via policies.

The event transformer 400 may transform events from a native format associated with a source to a standard format (e.g., CSV, Json, XML, etc.) that is more suitable for consumption by other components of the framework 300. In certain embodiments, the collector 308 may add information or metadata (timestamps, resource utilization, user credentials, etc.) to information gathered from events and store this information along with information about the event. Thus, in certain embodiments, the collectors 308 may augment information generated by events. In certain embodiments, the event filter 402 and event transformer 400 are configured via policy, whereas the event parser 404 is user-defined since it may be specific to a particular heterogeneous source such as a user application.

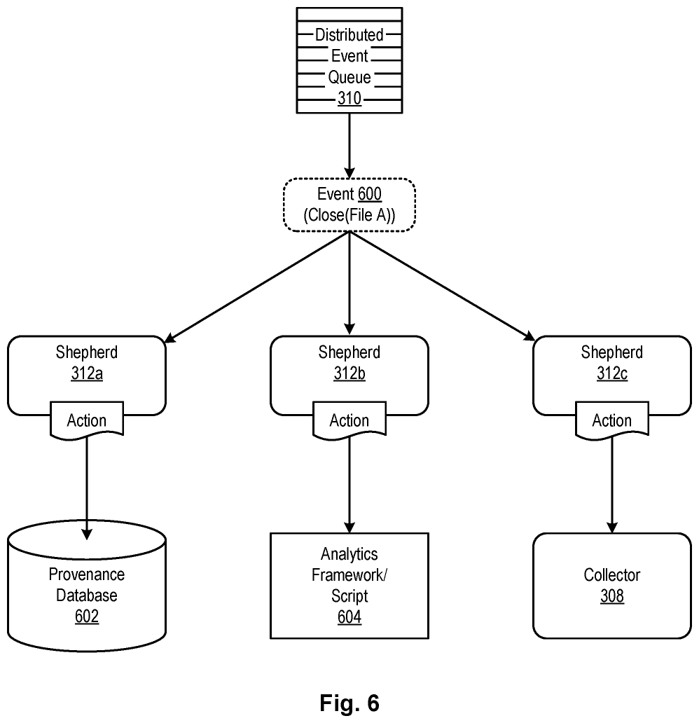

Referring to FIG. 6, while continuing to refer generally to FIG. 3, after events are stored in the distributed event queue 310, components referred to as shepherds 312 herein may consume the events in the distributed event queue 310. As shown in FIG. 6, shepherds 312 may perform various actions for events they consume. These actions may include, for example, storing an event in a provenance database 602. The actions may also include running a script 604 that may analyze an object (job, file, process, etc.) or perform other actions. For example, if a shepherd 312b performs an action in association with a file close event 600, the shepherd 312b may trigger execution of a script 604 that parses a file for some specific content. The actions may also include collecting additional digital provenance information in association with an event such as querying a kernel data structure or polling a log file (examples of collecting additional provenance on event triggers). For example, a shepherd 312c may trigger a collector 308 to gather additional digital provenance for a specific event, such as information from a log. This additional collection may occur on the same source where the event was detected, or on another source. For example, an event detected on a storage system 110 may trigger collection of additional digital provenance on a source such as a scheduler 302 or node 304.

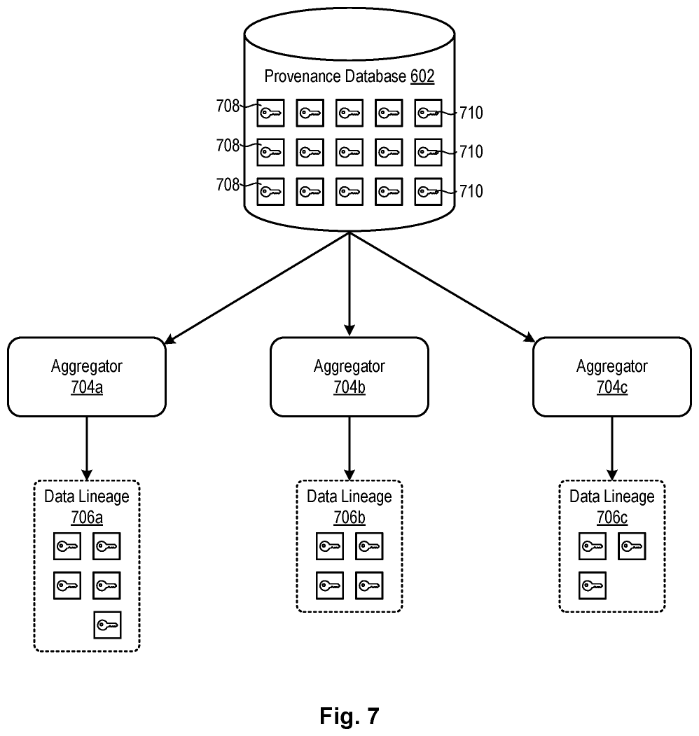

Referring to FIG. 7, in certain embodiments, different items of digital provenance that is stored in a provenance database 602 may be related. For example, different files may be opened, closed, changed, etc. by the same job and thus may be related by the job. In some cases, it may be important to collect all or multiple pieces 708 of digital provenance associated with the job. In order to determine relationships between different pieces 708 of digital provenance, association keys 710 may be stored with the digital provenance information. The association keys 710 may include, for example, process identifiers, host names, inode numbers, file names, jod identifiers, task process identifiers, and/or the like. Aggregators 704 may then be able to associate and mine digital provenance records 708 in the provenance database 602. This, in turn, may be used to construct partial or complete lineages 706 for particular objects (e.g., jobs, files, processes, etc.) within and across applications and sources. For example, the aggregators 704 may be used to collect all digital provenance associated with a particular job. This may enable a user or administrator, for example, to view all files that were opened, closed, changed, etc. by the job, even across different sources and systems. The association keys 710 may enable retrieval of this related data.

The systems and methods disclosed herein may be used in a variety of different applications and may be used to transparently collect provenance data across different layers of a software stack (e.g., operating system, application, scheduler, etc.). For example, the systems and methods disclosed herein may be used in automatic workflow engines. In such embodiments, shepherd actions may be used to construct complex workflow pipelines, where shepherd actions are initiated by the occurrence of different events. This may provide faster and more efficient processing by providing an event-driven pipeline. This may also enable digital provenance information to be collected across all stages of the workflow.

In other embodiments, systems and methods in accordance with the invention may be used to provide resource provisioning and/or optimization. For example, the framework 300 may be used to collect information about resource utilization of particular processes or jobs (e.g., how much memory, CPU time, network bandwidth, data, etc. was used by a particular process or job). This may be helpful with resource planning and provisioning when jobs or processes are rerun. It may also be helpful to optimize resource usage, such as by prefetching data, that may help the job or process to run faster and more efficiently in the future. Resource utilization is typically transient information that can be captured with the event-driven approach described herein. Stated otherwise, the event-driven approach disclosed herein enables capturing of transient provenance data.

In yet other embodiments, systems and methods in accordance with the invention may be used to provide a fine-grained billing system. The detailed digital provenance collected may enable more accurate and detailed tracking of resource usage for particular jobs and/or processes. This, in turn, may be used to determine the cost of running a particular job or process. This enables more fine-grained billing (and evidence supporting the billing) for resources utilized by a job or process.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method to collect digital provenance from heterogeneous sources, the method comprising:
detecting events generated by a plurality of heterogeneous sources;
filtering the events to extract relevant events;
transforming the relevant events into a standard format and saving the relevant events in a queue;
consuming each relevant event in the queue, wherein consuming comprises determining an action to be performed for the relevant event in the queue, the action involving collecting digital provenance associated with the relevant event and executing the action;
providing an association key for the digital provenance collected for each event; and
aggregating the digital provenance by association key to generate a lineage for a data object across the heterogeneous sources.

2. The method of claim 1, wherein the data object comprises at least one of a job, file, and process.

3. The method of claim 1, wherein the heterogeneous sources comprise at least one of applications, operating systems, and schedulers.

4. The method of claim 1, wherein executing the action comprises collecting additional digital provenance from sources that do not natively generate events.

5. The method of claim 1, wherein executing the action comprises saving the digital provenance in a database.

6. The method of claim 1, wherein executing the action comprises executing a script.

7. The method of claim 1, wherein detecting events generated by the plurality of heterogeneous sources comprises periodically polling logs of the plurality of heterogeneous sources in order to detect the events.

8. A computer program product to collect digital provenance from heterogeneous sources, the computer program product comprising a non-transitory computer-readable storage medium having computer-usable program code embodied therein, the computer-usable program code configured to perform the following when executed by at least one processor:
detect events generated by a plurality of heterogeneous sources;
filter the events to extract relevant events;
transform the relevant events into a standard format and save the relevant events in a queue;
consume each relevant event in the queue, wherein consuming comprises determining an action to be performed for the relevant event in the queue, the action involving collecting digital provenance associated with the relevant event and executing the action;
provide an association key for the digital provenance collected for each event; and
aggregate the digital provenance by association key to generate a lineage for a data object across the heterogeneous sources.

9. The computer program product of claim 8, wherein the data object comprises at least one of a job, file, and process.

10. The computer program product of claim 8, wherein the heterogeneous sources comprise at least one of applications, operating systems, and schedulers.

11. The computer program product of claim 8, wherein executing the action comprises collecting additional digital provenance from sources that do not natively generate events.

12. The computer program product of claim 8, wherein executing the action comprises saving the digital provenance in a database.

13. The computer program product of claim 8, wherein executing the action comprises executing a script.

14. The computer program product of claim 8, wherein detecting events generated by the plurality of heterogeneous sources comprises periodically polling logs of the plurality of heterogeneous sources in order to detect the events.

15. A system to collect digital provenance from heterogeneous sources, the system comprising:
at least one processor;
at least one memory device operably coupled to the at least one processor and storing instructions for execution on the at least one processor, the instructions causing the at least one processor to:
detect events generated by a plurality of heterogeneous sources;
filter the events to extract relevant events;
transform the relevant events into a standard format and save the relevant events in a queue;
consume each relevant event in the queue, wherein consuming comprises determining an action to be performed for the relevant event in the queue, the action involving collecting digital provenance associated with the relevant event and executing the action;
provide an association key for the digital provenance collected for each event; and
aggregate the digital provenance by association key to generate a lineage for a data object across the heterogeneous sources.

16. The system of claim 15, wherein the data object comprises at least one of a job, file, and process.

17. The system of claim 15, wherein the heterogeneous sources comprise at least one of applications, operating systems, and schedulers.

18. The system of claim 15, wherein executing the action comprises collecting additional digital provenance from sources that do not natively generate events.

19. The system of claim 15, wherein executing the action comprises saving the digital provenance in a database.

20. The system of claim 15, wherein detecting events generated by the plurality of heterogeneous sources comprises periodically polling logs of the plurality of heterogeneous sources in order to detect the events.
